(19) United States
(12) Patent Application Publication
(10) Pub. No.: US 2024/0161772 A1
(43) Pub. Date: May 16, 2024

(54) Gold-Copper Alloy In A Heat-Assisted Magnetic Recording Writer

(71) Applicant: Headway Technologies, Inc., Milpitas, CA (US)

(72) Inventors: Yukinori Ikegawa, Cupertino, CA (US); Koji Shimazawa, Cupertino, CA (US)

(21) Appl. No.: 17/985,698

(22) Filed: Nov. 11, 2022

(51) Int. Cl. G11B 5/21

(52) U.S. Cl. CPC G11B 5/21; G11B 2005/0021

(57) ABSTRACT

The present embodiments relate to a heat-assisted magnetic recording (HAMR) write head with a bi-layer planar plasmon generator (PPG) structure that includes both an iridium film as a plasmon generator (PG) layer and a gold-copper (AuCu) alloy as a bottom plasmonic layer. A HAMR write head can include a main pole including a tip portion disposed adjacent to an air-bearing surface (ABS). The HAMR write head can also include a heat sink disposed adjacent to the main pole and a bi-layer structure planar plasmon generator (PPG) structure. The PPG structure can also include a plasmon generator (PG) layer comprising an Iridium (Ir) film and a bottom plasmonic layer comprising a gold-copper (Au—Cu) alloy.

### TECHNICAL FIELD

Embodiments of the invention relate to the field of electro-mechanical data storage devices. More particularly, embodiments of the invention relate to heat-assisted magnetic recording (HAMR) write heads with bi-layer planar plasmon generating (PPG) structures.

### BACKGROUND

A hard-disk drive (HDD) can include a non-volatile storage device that is housed in a protective enclosure and stores digitally encoded data on one or more circular disks having magnetic surfaces (a disk may also be referred to as a platter). When an HDD is in operation, each magnetic-recording disk can be rapidly rotated by a spindle system. Data can be written to a magnetic-recording disk using a write head which is positioned over a specific location of a disk. A write head can use a magnetic field to write data to the surface of a magnetic-recording disk.

In many cases, a write head can include heat-assisted magnetic recording (HAMR) techniques in interacting with a magnetic recording medium (e.g., a disk). HAMR can include heating a small region of the magnetic medium to near its Curie temperature where its coercivity and anisotropy are significantly reduced, and magnetic writing becomes easier to achieve even with weak write fields characteristic of small write heads in high recording density schemes. In HAMR, optical power from a light source can be converted into localized heating in a recording medium during a write process to temporarily reduce the field needed to switch the magnetizations of the medium grains. Thus, data storage density in a hard disk drive (HDD) can be further improved.

### SUMMARY

The present embodiments relate to a heat-assisted magnetic recording (HAMR) write head with a bi-layer planar plasmon generator (PPG) structure that includes both an iridium film as a plasmon generator (PG) layer and a gold-copper (AuCu) alloy as a bottom plasmonic layer.

In a first example embodiment, a heat-assisted magnetic recording (HAMR) write head is provided. The HAMR write head can include a main pole including a tip portion disposed adjacent to an air-bearing surface (ABS). The main pole can be configured to direct a magnetic field toward a magnetic recording medium to interact with the magnetic recording medium.

The HAMR write head can also include a heat sink disposed adjacent to the main pole and a bi-layer structure planar plasmon generator (PPG) structure. The PPG structure can also include a plasmon generator (PG) layer comprising an Iridium (Ir) film and a bottom plasmonic layer comprising a gold-copper (Au—Cu) alloy.

In some instances, the bottom plasmonic layer comprises a portion of copper that is between 3 and 15 percent of the gold-copper alloy.

In some instances, a grain size of the bottom plasmonic layer is at least 30 nanometers.

In some instances, the HAMR device can further include a first dielectric spacer layer disposed between the main pole and the PG layer.

In some instances, the HAMR device can further include a second dielectric spacer layer disposed adjacent to the bottom plasmonic layer.

In some instances, the bottom plasmonic layer is disposed over the second dielectric spacer.

In some instances, a portion of the bottom plasmonic layer is removed via an etching process according to a resist mask disposed above the bottom plasmonic layer.

In some instances, a body layer is disposed above the PG layer, the body layer comprising Iridium, and wherein the first dielectric spacer is disposed above the body layer.

In another example embodiment, a device is provided. The device can include a main pole and a heat sink disposed adjacent to the main pole. The device can also include a bi-layer structure planar plasmon generator (PPG) structure. The PPG structure can include a plasmon generator (PG) layer comprising an Iridium (Ir) film and a bottom plasmonic layer comprising a gold-copper (Au—Cu) alloy. The device can also include a body layer disposed adjacent to the Ir film. The body layer can comprise Iridium. The device can also include a first dielectric spacer layer disposed between the main pole and the PG layer. The device can also include a second dielectric spacer layer disposed adjacent to the bottom plasmonic layer.

In some instances, a first portion of the bottom plasmonic layer is removed via an etching process based on a resist mask disposed above the bottom plasmonic layer.

In some instances, the bottom plasmonic layer is created by a manufacturing process that includes adding a reactive-ion etching (RIE) stopper layer over the second dielectric layer. The process can also include disposing a dielectric cladding over the RIE stopper layer. A portion of the dielectric cladding can be removed via an RIE etching process to form a cavity. The process can also include depositing the bottom plasmonic layer over the dielectric cladding and within the cavity. The process can also include removing a second portion of the bottom plasmonic layer to be substantially flat with the dielectric cladding.

In some instances, the bottom plasmonic layer comprises between 3 and 15 percent copper.

In some instances, a grain size of the bottom plasmonic layer is at least 30 nanometers.

In another example embodiment, method for manufacturing a heat-assisted magnetic recording (HAMR) write head is provided. The method can include disposing a bottom plasmonic layer over a first dielectric layer. The bottom plasmonic layer can include a gold-copper (Au—Cu) alloy. The method can also include disposing a plasmon generator (PG) layer comprising an Iridium (Ir) film over the bottom plasmonic layer.

The method can also include disposing a body layer comprising Iridium over the PG layer. The method can also include disposing a second dielectric layer and a heat sink over the body layer. The method can also include disposing a main pole comprising a magnetic metallic material over the second dielectric layer and the heat sink.

In some instances, the method can also include disposing a non-magnetic main pole spacer over the second dielectric layer and the heat sink. The non-magnetic main pole spacer can be disposed between the main pole and the second dielectric layer and the heat sink.

In some instances, the method can also include adding a resist mask over the bottom plasmonic layer and performing an etching process to remove a first portion of the bottom plasmonic layer.

In some instances, the method can also include patterning the body layer and the PG layer to a target dimension.

In some instances, the method can also include adding a reactive-ion etching (RIE) stopper layer over the second dielectric layer. The method can also include disposing a dielectric cladding over the RIE stopper layer. A portion of the dielectric cladding can be removed via an etching process to form a cavity. The method can also include depositing the bottom plasmonic layer over the dielectric cladding and within the cavity. The method can also include removing a second portion of the bottom plasmonic layer to be substantially flat with the dielectric cladding.

In some instances, the cavity is formed by performing any of a RIE etching process or an ion beam etching (IBE) etching process.

In some instances, responsive to depositing the bottom plasmonic layer over the dielectric cladding and within the cavity, the method further comprises adding a dielectric film over the bottom plasmonic layer. The dielectric film can be removed along with the removal of the second portion of the bottom plasmonic layer.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1A illustrates a graph of a hardness vs. Cu ratio of the AuCu alloy according to some embodiments.

FIG. 1B illustrates a phase diagram of an example Rh—Cu system according to some embodiments.

FIG. 1C illustrates a graph of an example relationship between a resistivity vs. Cu at varying percentages according to some embodiments.

FIG. 1D illustrates a graph of an example relationship between n and Cu at varying percentages according to some embodiments.

FIG. 1E illustrates a graph of an example relationship between k and Cu at varying percentages according to some embodiments.

FIG. 1F illustrates a graph of an example AuCu grain size vs. a Cu ratio according to some embodiments.

FIG. 1G is an illustration of an example grain structure and size of a AuCu alloy according to some embodiments.

FIG. 2 is a cross-section view of a portion of an example HAMR writer according to some embodiments.

FIG. 3 illustrates a cross-section view of a write head as described herein.

FIG. 4 is an ABS view of a portion of a HAMR writer according to some embodiments.

FIG. 5 is a block diagram of a first example part of a process to apply a AuCu film and an Ir film to a writer according to some embodiments.

FIG. 6 is a block diagram of a second example part of a process to apply a AuCu film and an Ir film to a writer according to some embodiments.

FIG. 7 is a block diagram of a third example part of a process to apply a AuCu film and an Ir film to a writer according to some embodiments.

FIG. 8 is a block diagram of a fourth example part of a process to apply a AuCu film and an Ir film to a writer according to some embodiments.

FIG. 9 is a block diagram of a fifth example part of a process to apply a AuCu film and an Ir film to a writer according to some embodiments.

FIG. 10 is a block diagram of a sixth example part of a process to apply a AuCu film and an Ir film to a writer according to some embodiments.

FIG. 11A is a cross-section view of a seventh example part of a process to apply a AuCu film and an Ir film to a writer according to some embodiments.

FIG. 11B is a top view of a seventh example part of a process to apply a AuCu film and an Ir film to a writer according to some embodiments.

FIG. 12 is a block diagram of an eighth example part of a process to apply a AuCu film and an Ir film to a writer according to some embodiments.

FIG. 13 is a block diagram of a ninth example part of a process to apply a AuCu film and an Ir film to a writer according to some embodiments.

FIG. 14 is a block diagram of a tenth example part of a process to apply a AuCu film and an Ir film to a writer according to some embodiments.

FIG. 15 is a block diagram of a first example part of a process to manufacture a AuCu bottom plasmonic layer according to some embodiments.

FIG. 16 is a block diagram of a second example part of a process to manufacture a AuCu bottom plasmonic layer according to some embodiments.

FIG. 17 is a block diagram of a third example part of a process to manufacture a AuCu bottom plasmonic layer according to some embodiments.

FIG. 18 is a block diagram of a fourth example part of a process to manufacture a AuCu bottom plasmonic layer according to some embodiments.

FIG. 19 is a block diagram of a fifth example part of a process to manufacture a AuCu bottom plasmonic layer according to some embodiments.

FIG. 20 is a block diagram of a sixth example part of a process to manufacture a AuCu bottom plasmonic layer according to some embodiments.

FIG. 21 is a block diagram of a seventh example part of a process to manufacture a AuCu bottom plasmonic layer according to some embodiments.

FIG. 22 is a block diagram of an eighth example part of a process to manufacture a AuCu bottom plasmonic layer according to some embodiments.

FIG. 23 is a block diagram of a ninth example part of a process to manufacture a AuCu bottom plasmonic layer according to some embodiments.

FIG. 24 is a block diagram of a tenth example part of a process to manufacture a AuCu bottom plasmonic layer according to some embodiments.

### DETAILED DESCRIPTION

A hard disk drive (HDD) can include a write head that can read and write digital data stored on a magnetic recording medium. As data capacity requirements increase for hard disk drives, the magnetic recording areal density may need a smaller grain size at the magnetic recording medium, which can reduce storage reliability and lifetime. To maintain reliability and the lifetime of the stored data, a thermal stability may be increased. As a consequence, the magnetic field generated by magnetic writer main pole as well as the current from the coil around the main pole may not be strong enough to switch the magnetic media bits for data recording.

In response, a write head can implement a heat-assisted magnetic recording (HAMR) technique. A HAMR write head can use heat energy to reduce the energy barrier of the grains of the magnetic recording media while writing the data with magnetic recording field. In many HAMR heads, the heating source can be produced by the means of near-field light. The near-field light can be generated from plasmons excited by irradiation with light through a metal layer. In HAMR, a laser beam from through the waveguide a laser diode can be used as the irradiation source. The metal films may be able to generate near field efficiently by exciting Surface Plasmon (SP) or surface wave of free electrons bounded on the metal-dielectric interface. A structure and geometry of the Plasmon Generator (PG) can be engineered to enable efficient energy transfer from waveguide to PG, to excite local surface plasmon resonance, and to utilize lightning rod effect to further improve field confinement. This kind of metallic nanostructure can include the PG or Near-Field Transducer (NFT).

In many cases, a self-aligned gold-rhodium (Au—Rh) bi-layer structure can be used. This structure can be called “Rh-D1,” with a write head design being a bi-layer PPG design. The PG materials not only need high SP efficient materials but also can be reliable under high temperature irradiation during HAMR/thermally-assisted magnetic recording (TAMR) writing process. Rhodium can be used due to its good optical properties due to the large availability of free electrons and the low optical absorption in plasmonic metals. In many cases, Au, Ag Cu or alloys can be used as the bottom layer under Rh layer. This layer can be the bottom plasmonic layer. Under high temperature writing operation, the bottom plasmonic layer can cause agglomeration that increases its density due to thermal stress, which can cause degradation of ADC performance.

Another material that can be used in the bottom plasmonic layer can include Au due to its plasmonic characteristics. For instance, Au has a softening temperature of about 100degC, but the PG temperature in writing operation can exceed that. Au film generally can have a density of only about 90% against the bulk state. Au exceeding the softening temperature can shrink by discharging vacancy to the outside. As a result, the Au layer near the ABS may have a recession and the recording characteristics are greatly degraded. For example, when Au with 95% density has a length of 1000 nm, the recession reaches 50 nm because of the vacancy discharge. The amount of recession can greatly degrade ADC performance. The amount of vacancy can depend on the grain size of the material. Further, with a larger the grain size, the amount of vacancy can be smaller.

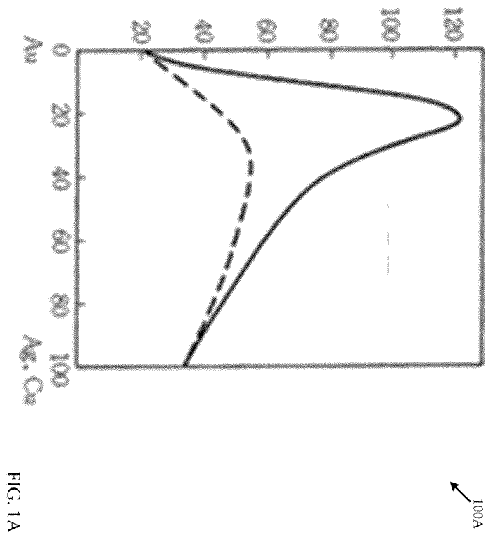

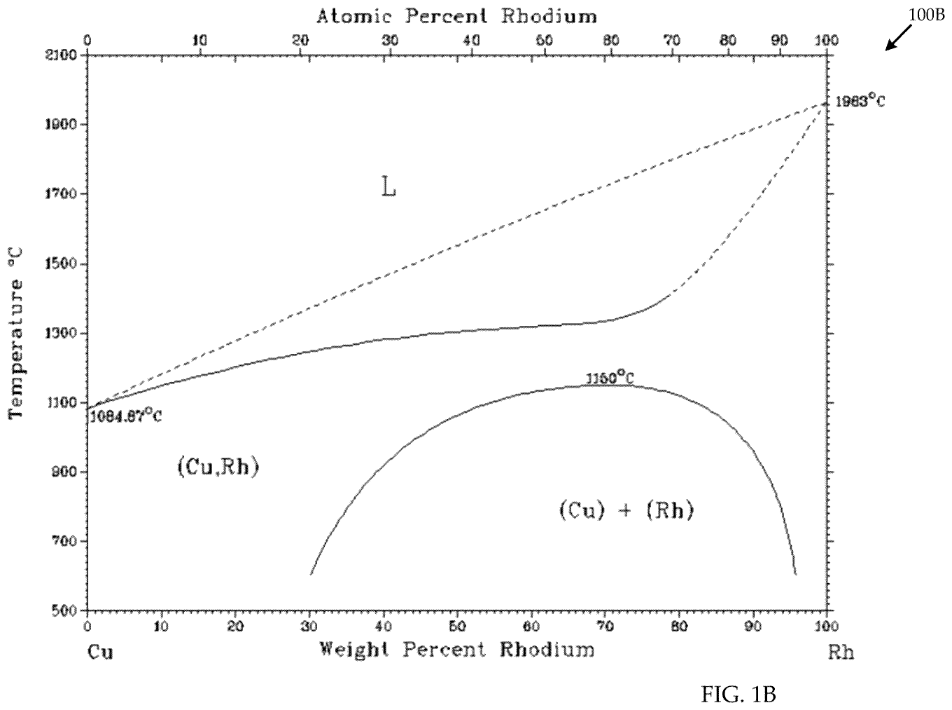

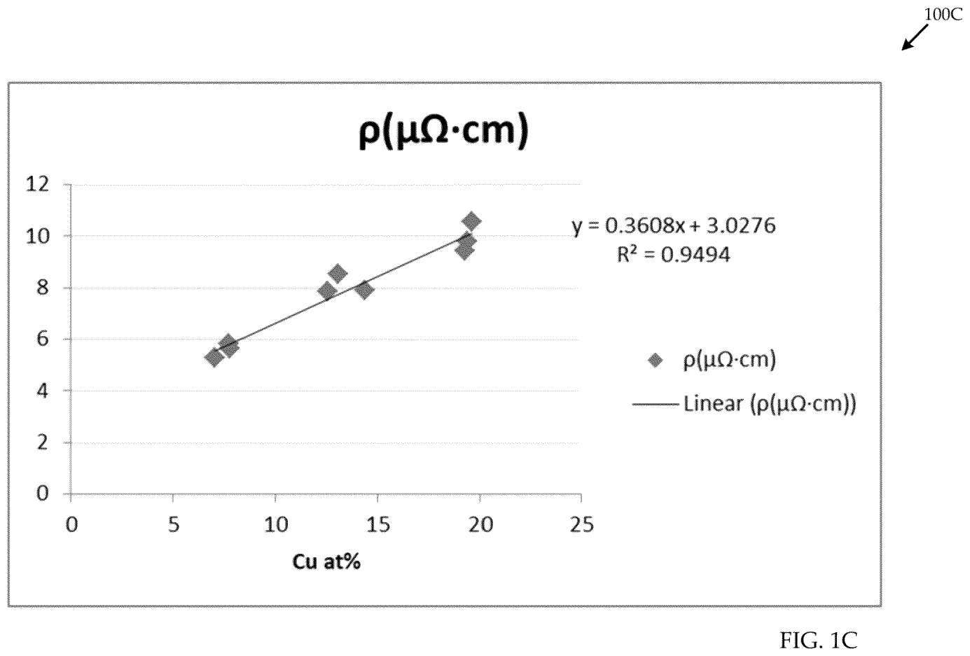

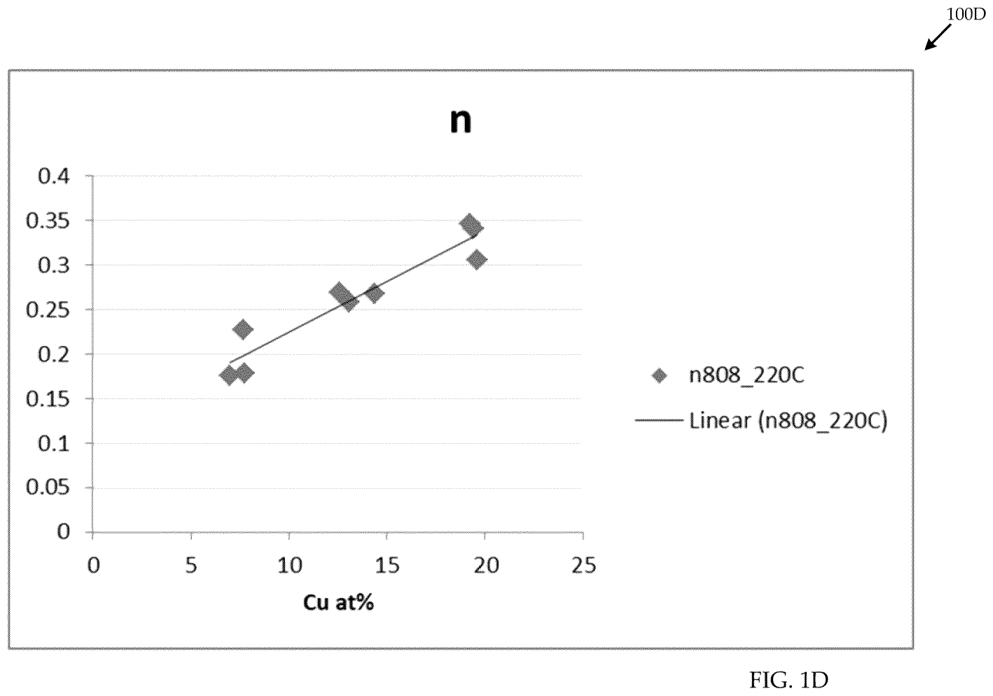

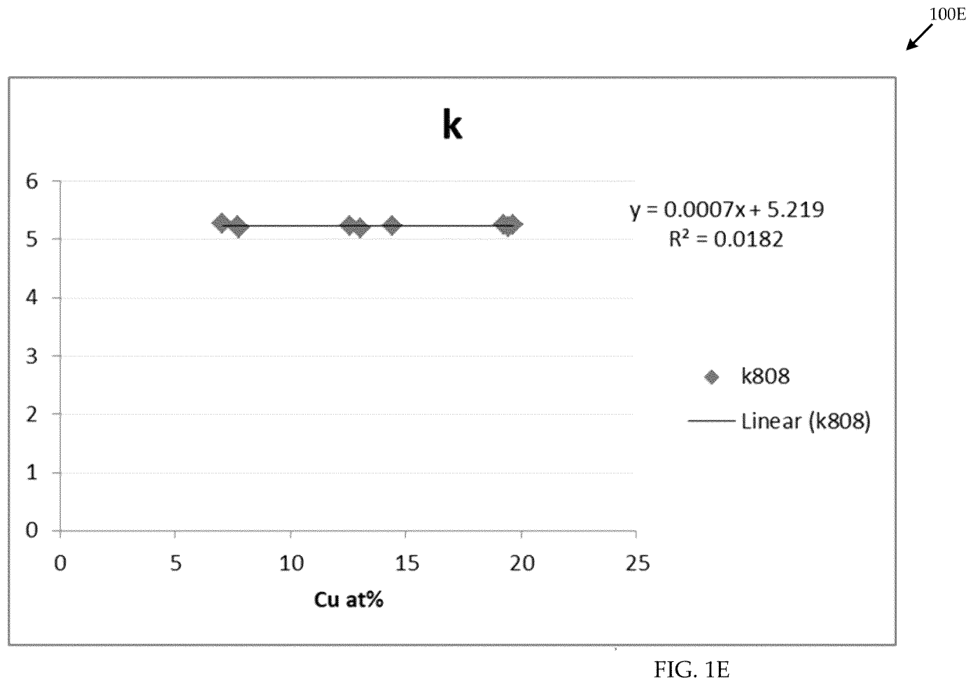

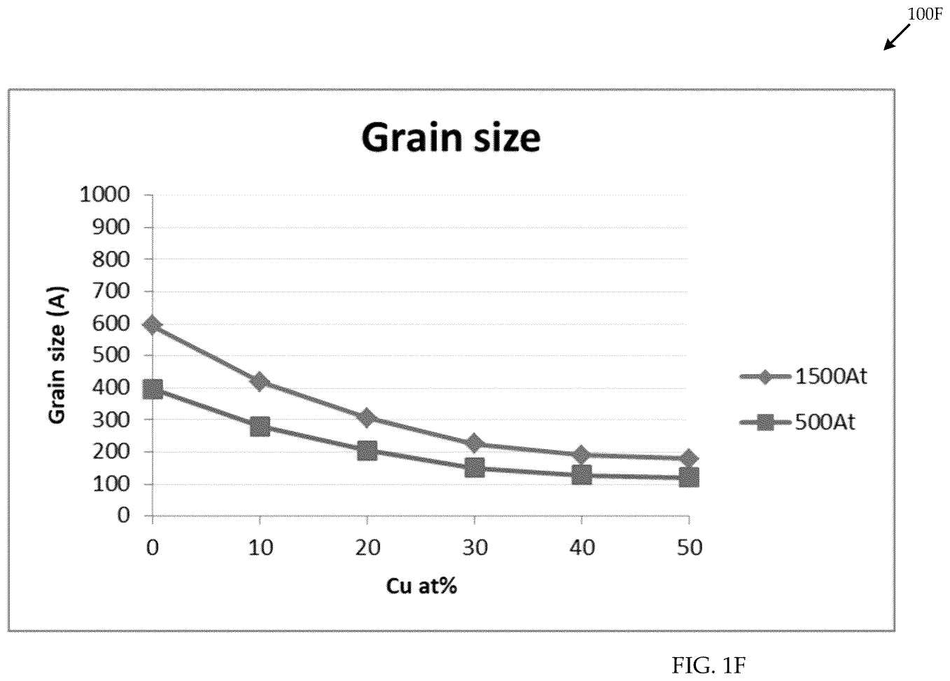

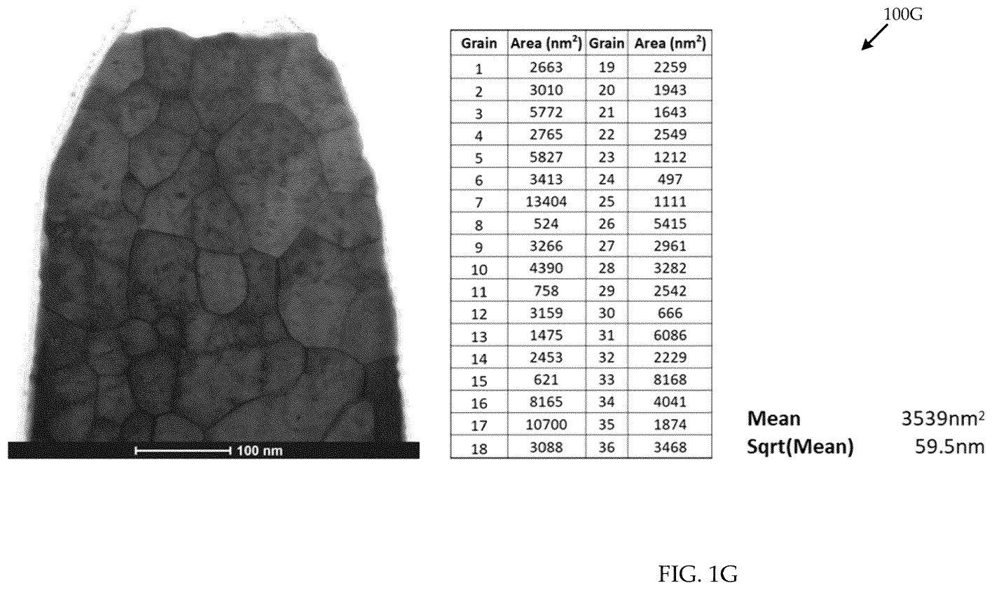

FIGS. 1A-1G illustrate various properties of materials when a composition of the AuCu alloy is changed. For example, FIG. 1A illustrates a graph 100A of a hardness vs. Cu ratio of the AuCu alloy. FIG. 1B illustrates a phase diagram 100B of an example Rh—Cu system. FIG. 1C illustrates a graph 100C of an example relationship between a resistivity vs. Cu at varying percentages. FIG. 1D illustrates a graph 100D of an example relationship between n and Cu at varying percentages. FIG. 1E illustrates a graph 100E of an example relationship between k and Cu at varying percentages. FIG. 1F illustrates a graph 100F of an example AuCu grain size vs. a Cu ratio.

The grain size in FIGS. 1A-1F can be defined by the square root of the area of the grain measured from images. An example of an image is shown in FIG. 1G. FIG. 1G is an illustration 100G of an example grain structure and size of a AuCu alloy.

TABLE 1

| | | | | | | AuCu |
|---|---|---|---|---|---|---|
| | | | | | PG | layer |
| | | | | Thermal | temper- | temper- |
| | | | | Conductivity | ature | ature |
| Cu at % | n | k | ρ [μΩcm] | [W/mK] | [degC.] | [degC.] |
| 0 | 0.110 | 5.219 | 3.03 | 242 | 305 | 138 |
| 3 | 0.145 | 5.221 | 4.11 | 178 | 314 | 155 |
| 5 | 0.167 | 5.223 | 4.83 | 152 | 319 | 164 |
| 8 | 0.202 | 5.225 | 5.91 | 124 | 325 | 177 |
| 10 | 0.224 | 5.226 | 6.64 | 110 | 329 | 184 |
| 12 | 0.247 | 5.227 | 7.36 | 99 | 333 | 191 |
| 15 | 0.281 | 5.230 | 8.44 | 87 | 338 | 200 |
| 18 | 0.316 | 5.232 | 9.52 | 77 | 342 | 208 |
| 20 | 0.338 | 5.233 | 10.24 | 71 | 345 | 213 |
| 22 | 0.361 | 5.234 | 10.97 | 67 | 347 | 218 |
| 25 | 0.395 | 5.237 | 12.05 | 61 | 351 | 224 |

Further, Table 1 can show the results of simulating the head temperature during head operation using the experimental data from FIGS. 1C-1E. When the amount of Cu added exceeds 15 at %, the temperature of the AuCu layer can exceed 200degC, which can be twice the softening temperature of Au.

Adding Cu to Au to make an AuCu alloy can increase the hardness and can be effective in solving the recession problem mentioned above. As shown in FIG. 1A, the hardness can be increased by adding Cu up to 20 at % in Au. However, various issues may arise when using it for a HAMR head with an Rh-D1 structure. For instance, addition of Cu to Au can change the plasmonic characteristics of the Au in an unfavorable direction. Therefore, the composition and film structure may need to be carefully designed. Further, adding additive elements such as Cu to Au can cause a decrease in grain size. This may not be preferable because it can mean increasing the vacancy that is discharged at high temperature operation. As shown in FIG. 1B, Rh and Cu can form an alloy, and the Cu can migrate to the Rh layer at high temperatures, changing the composition of the AuCu alloy. Therefore, the PG material may need to be selected from materials other than Rh.

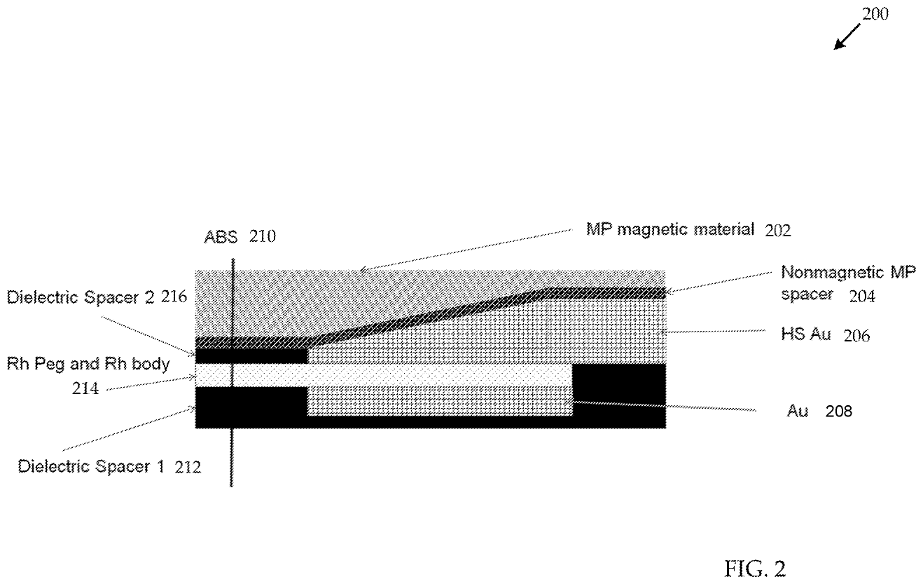

FIG. 2 is a cross-section view of a portion of an example HAMR writer 200. Upon the deposition of PEG Rh film, the substrate can include a BPG (Bottom Plasmon Generator) Au portion and a Dielectric Spacer 1 portion.

As shown in FIG. 2, the writer 200 can include a main pole (MP) magnetic material 202 disposed above a non-magnetic MP spacer 204. A tip portion of the MP 202 can be disposed adjacent to an air bearing surface (ABS) 210. The spacer 204 can be disposed above an Au heat sink 206 and a second dielectric spacer 216. Further, a Rh PEG and Rh body 214 can be disposed below heat sink 206 and spacer 216. A first dielectric spacer 212 can be disposed below the PEG 214 and disposed around an Au BPG 208. The writer 200 can be configured to interact with a magnetic recording medium 218. For instance, the main pole 202 can direct a magnetic field to the medium 218 to write digital data to the medium 218.

The present embodiments can relate to a design using a bi-layer PPG structure that has Iridium as PG layer. Cu and Iridium may have restricted mutual solubility, which can be unlike the behavior of Cu with Rh, in the same group as Ir, or with the neighboring Pt and Pd, all of which may exhibit miscibility in the solid. Further, the present embodiments can limit the amount of Cu added to Au from 3% to 15%. At the same time, the grain size can be 30 nanometers (nm) or larger by adjusting the film formation method.

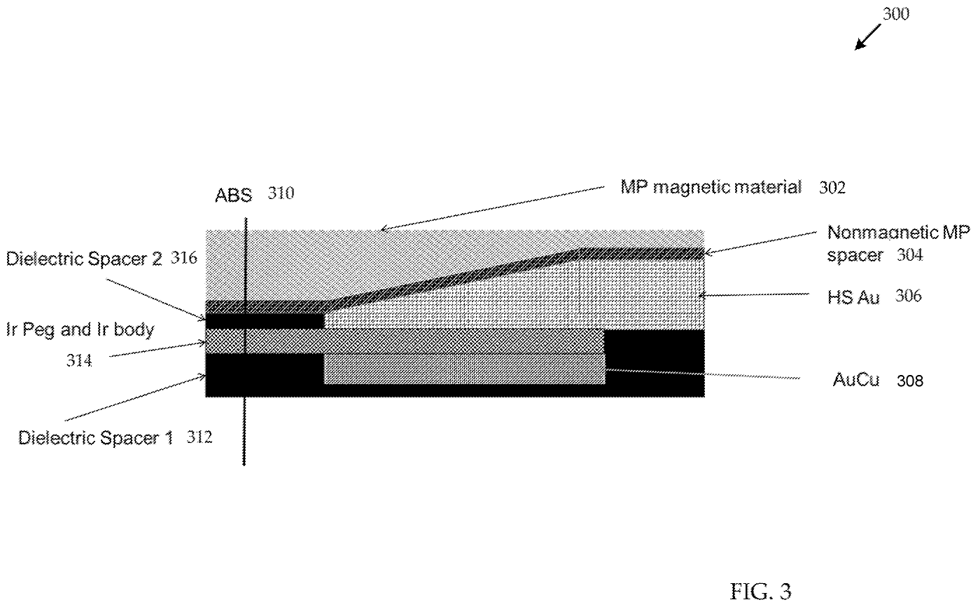

FIG. 3 illustrates a cross-section view of a write head 300 as described herein. In FIG. 3, the writer 300 can have a full film Ir seed layer and Ir body film grown partially on a Dielectric Spacer 1 and on the BPG Au. Above the Dielectric Spacer 1, the Ir seed and film can then be patterned as a narrow rod facing writer ABS direction. Above BPG Au, the Ir seed and film can be patterned into a wider parabola shape.

As shown in FIG. 3, a first dielectric spacer 312 can be disposed around an AuCu BPG 308. The writer 300 can further include a Ir PEG and Ir body 314 disposed above the BPG 308. And below a second dielectric spacer 316 and Au heat sink 306.

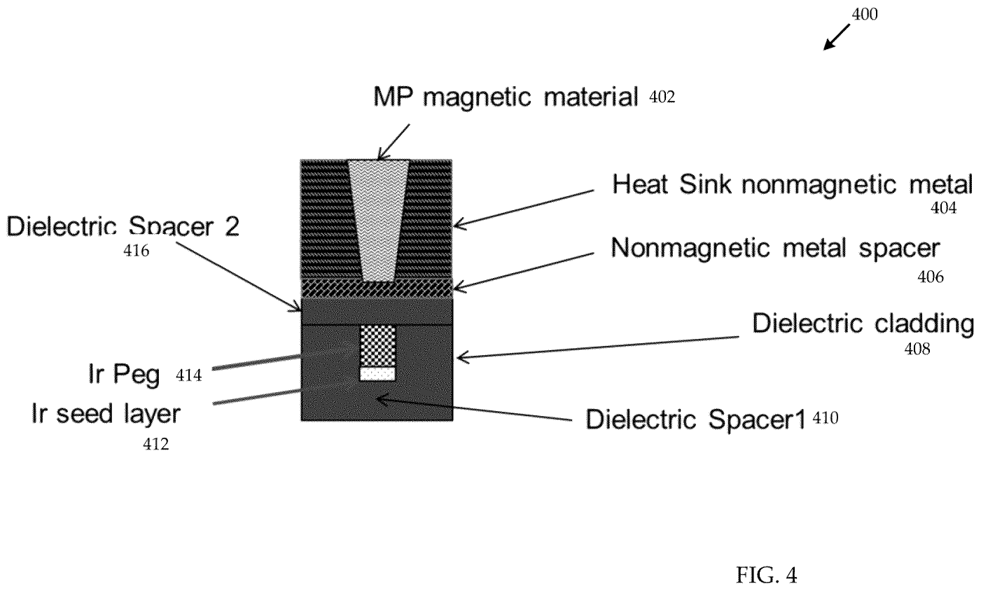

FIG. 4 is an ABS view of a portion of a HAMR writer 400. For example, the writer 400 can include a MP magnetic material 402 disposed within a heat sink 404 including a non-magnetic metal. Further, below the MP 402 can include a non-magnetic metal spacer 406. The spacer 406 can be disposed above a second dielectric spacer 416. A dielectric cladding 408 can be disposed around a first dielectric spacer 410. Further, the Ir PEG 414 and an Ir seed layer 412 can be disposed between the dielectric spacer 410.

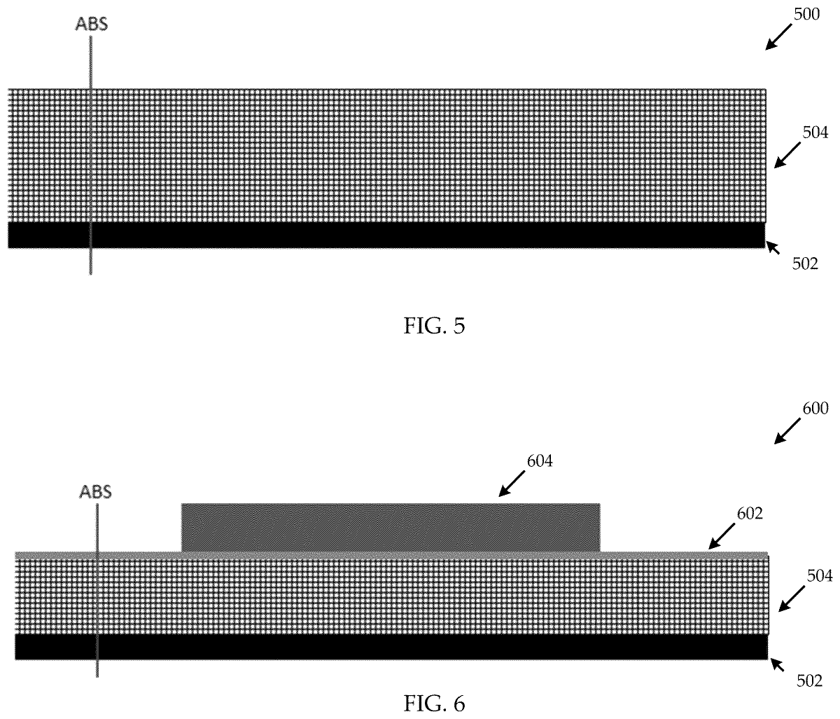

In some instances, a AuCu film and Ir film can be applied to a writer as described herein. FIGS. 5-14 illustrate an example process for applying an AuCu film and an Ir film to a writer.

FIG. 5 is a block diagram 500 of a first example part of a process to apply a AuCu film and an Ir film to a writer. In FIG. 5, a BPG AuCu layer 504 can be coated on a first dielectric spacer 502. The thickness of the BPG 502 can be sufficient to keep a specific grain size. For example, if the final BPG AuCu film thickness is 50 nm, the initial BPG can be set to 150 nm, which is three times that. With such a device, it is possible to increase the grain size of AuCu (e.g., as shown in FIGS. 1A-1F). After coating the AuCu, an annealing process can be applied to reduce the thickness via an ion beam etching (IBE) process.

FIG. 6 is a block diagram 600 of a second example part of a process to apply a AuCu film and an Ir film to a writer. In FIG. 6, a thin metal layer 602 can be added to enable exposure focusing a surface of a resist. For example, a metal including nickel and iron (NiFe) may be used due to its lower reflection. Then, photolithography can be applied (e.g., adding 604) to make resist pattern as an IBE mask.

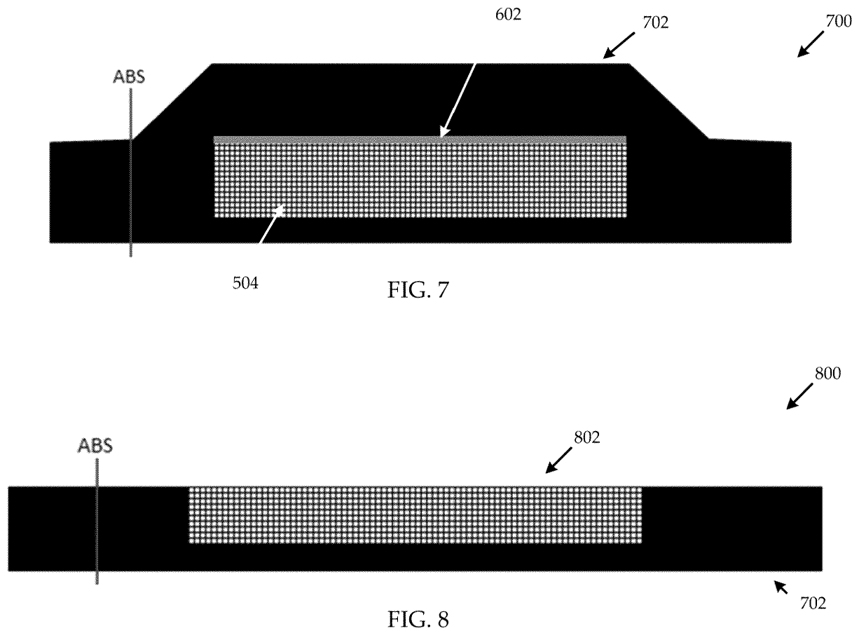

FIG. 7 is a block diagram 700 of a third example part of a process to apply a AuCu film and an Ir film to a writer. In FIG. 7, a dielectric spacer 702 can be deposited over the metal layer 602 and the BPG 504.

FIG. 8 is a block diagram 800 of a fourth example part of a process to apply a AuCu film and an Ir film to a writer. In FIG. 8, a CMP and IBE process can be applied to complete a flattening process. For instance, a portion of the spacer 702 and the BPG 504 can be removed (e.g., removed portion 802).

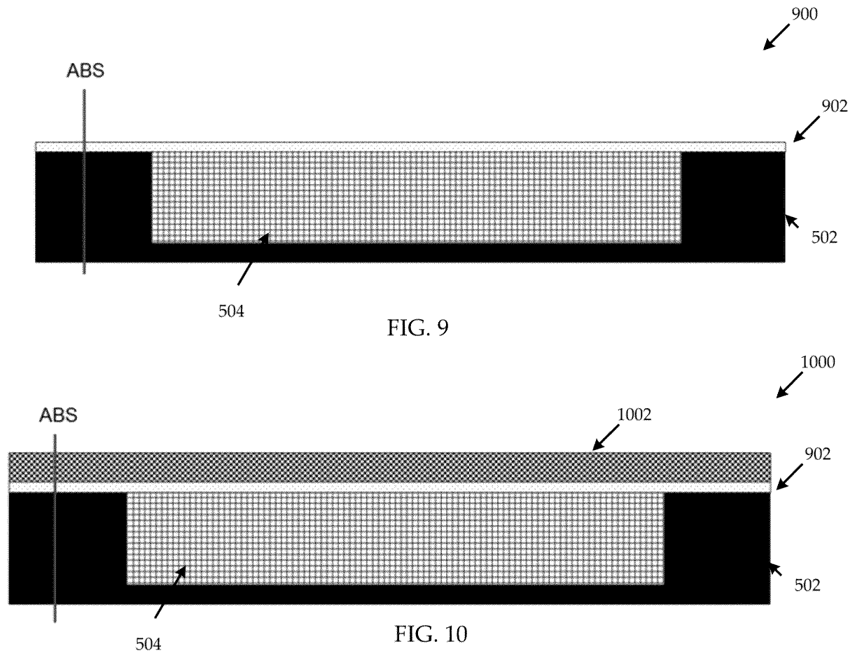

FIG. 9 is a block diagram 900 of a fifth example part of a process to apply a AuCu film and an Ir film to a writer. In FIG. 9, the Ir seed layer 902 can be disposed above the BPG AuCu 504 and the first dielectric spacer 502. Here, Al2O3 or a dielectric containing Al2O3 as a main component can be used for Dielectric Spacer 1. In some instances, a structural disorder layer can be formed on the surface of Dielectric Spacer 1, which can enhance adhesion to the Ir seed layer.

FIG. 10 is a block diagram 1000 of a sixth example part of a process to apply a AuCu film and an Ir film to a writer. In FIG. 10, a body Ir layer 1002 can be deposited on the Ir seed layer 902.

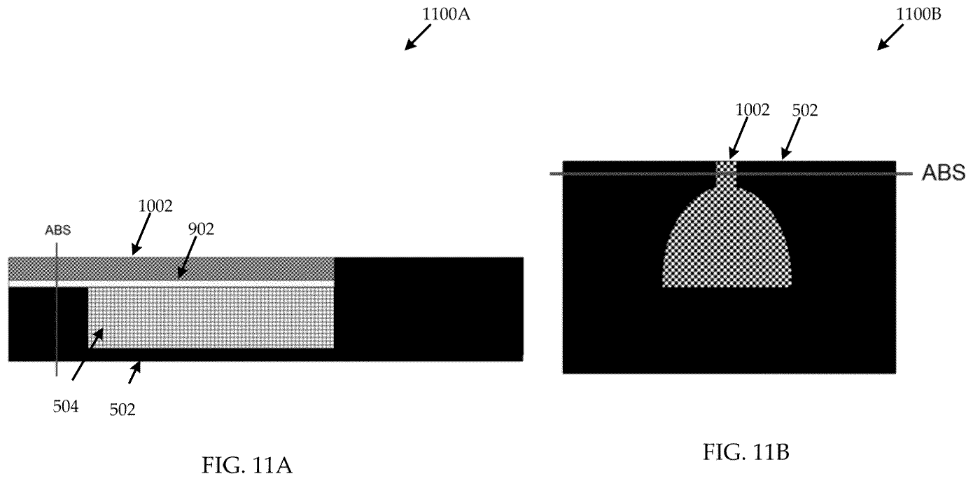

FIGS. 11A-B are block diagrams 1100A-B of a seventh example part of a process to apply a AuCu film and an Ir film to a writer. FIG. 11A is a cross-section view of a write head. FIG. 11B is a top view of a write head. In FIGS. 11A-B, the Ir body 1002 and the seed layer 902 can be patterned and polished to a PEG dimension target.

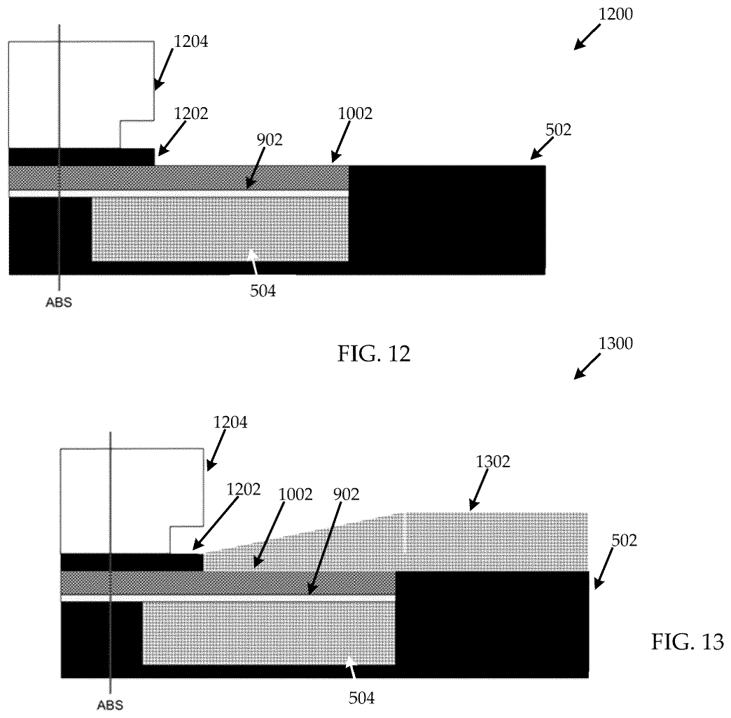

FIG. 12 is a block diagram 1200 of an eighth example part of a process to apply a AuCu film and an Ir film to a writer. In FIG. 12, a second dielectric spacer 1202 can be applied over the body layer 1002. Further, a resist mask 1204 can be applied on the Ir PEG and a part of the Ir body. An IBE process can be performed to remove part of the spacer 1202.

FIG. 13 is a block diagram 1300 of a ninth example part of a process to apply a AuCu film and an Ir film to a writer. In FIG. 13, a heat sink 1302 can be added over the spacer 502 and the body layer 1002. The heat sink can include gold (Au) and can be added by an IBD process with an incident angle adjusted. The heat sink can think near the resist due to a shadow effect of the resist.

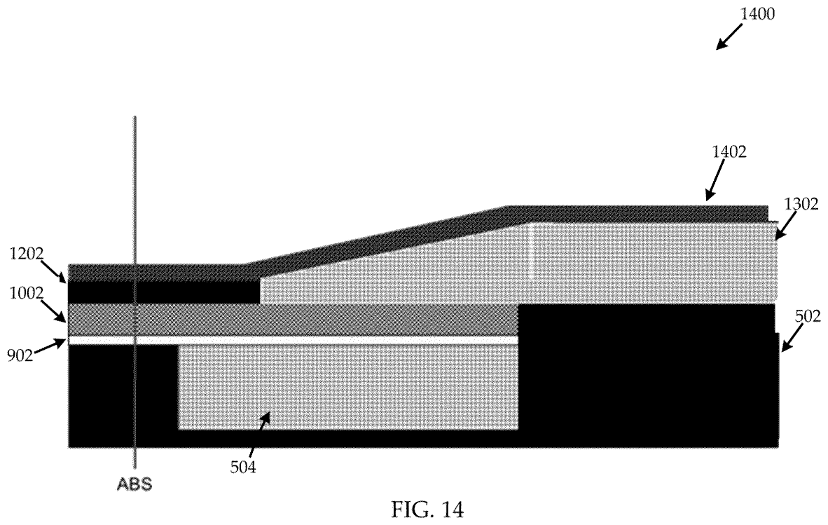

FIG. 14 is a block diagram 1400 of a tenth example part of a process to apply a AuCu film and an Ir film to a writer. In FIG. 14, a non-magnetic metallic spacer layer 1402 can be disposed over the heat sink 1302 and the second spacer 1202.

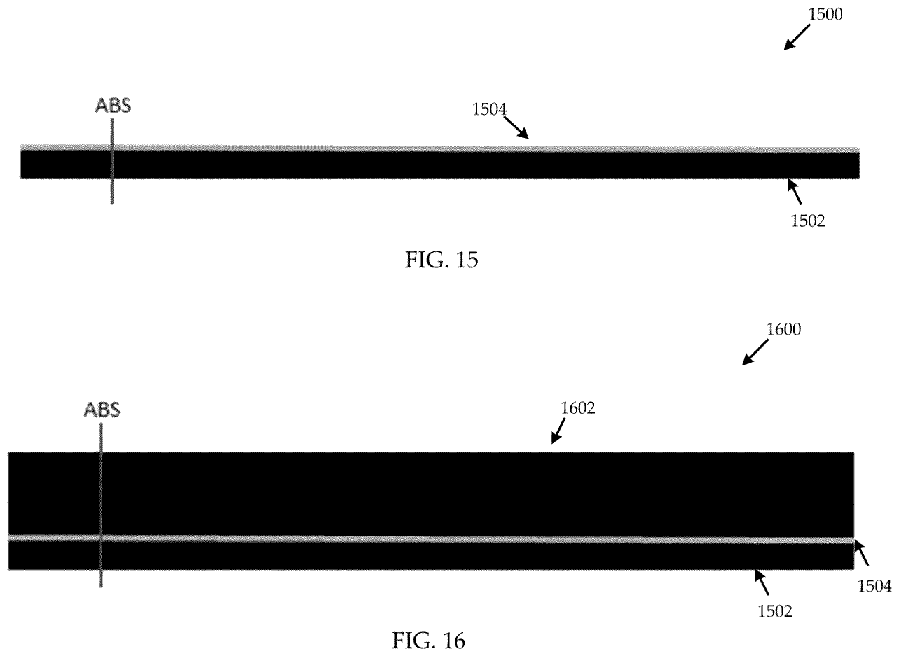

In another example embodiment, a AuCu BPG can be manufactured by a cavity process. A manufacturing process can be illustrated in FIGS. 15-24.

FIG. 15 is a block diagram 1500 of a first example part of a process to manufacture a AuCu bottom plasmonic layer. In FIG. 15, a RIE stopper layer 1504 can be coated on a dielectric spacer 1502. The stopper layer 1504 can include a low optical loss film which can include a k<0.001. The thickness can be determined by etching selectivity ratio between the dielectric spacer and the stopper, for example, Sm2O3. For example, the thickness can include 50A.

FIG. 16 is a block diagram 1600 of a second example part of a process to manufacture a AuCu bottom plasmonic layer. In FIG. 16, another dielectric spacer 1602 (dielectric spacer 1) can be deposited on the stopper layer 1504 by sputtering. The target of the thickness can be included final AuCu BPG thickness target, which can be around 500A plus a process etching margin, which can be around 200A, with a total thickness of around 700A.

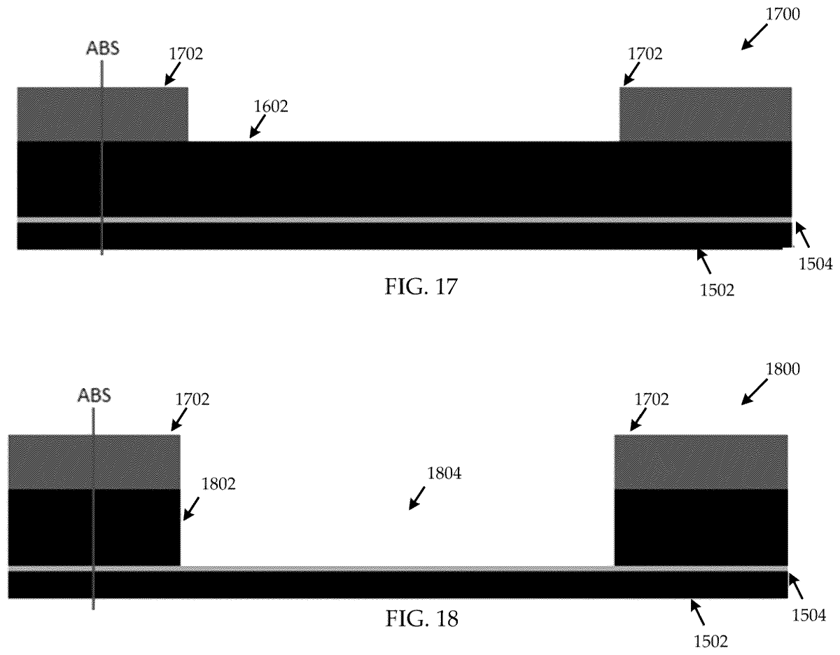

FIG. 17 is a block diagram 1700 of a third example part of a process to manufacture a AuCu bottom plasmonic layer. In FIG. 17, a resist pattern can be patterned on to define cavity BPG pattern. For example, a resist component 1702 can be disposed above the dielectric spacer 1602. A resist thickness can be targeted enough to remain after a RIE process.

FIG. 18 is a block diagram 1800 of a fourth example part of a process to manufacture a AuCu bottom plasmonic layer. In FIG. 18, a portion of the dielectric spacer can be removed (e.g., removed from cavity 1804, leaving remaining portion 1802). After an RIE process, the portion of the dielectric spacer can be removed, and etching can stop by an RIE stopper when the process reaches stopper 1504 to control etching depth accurately.

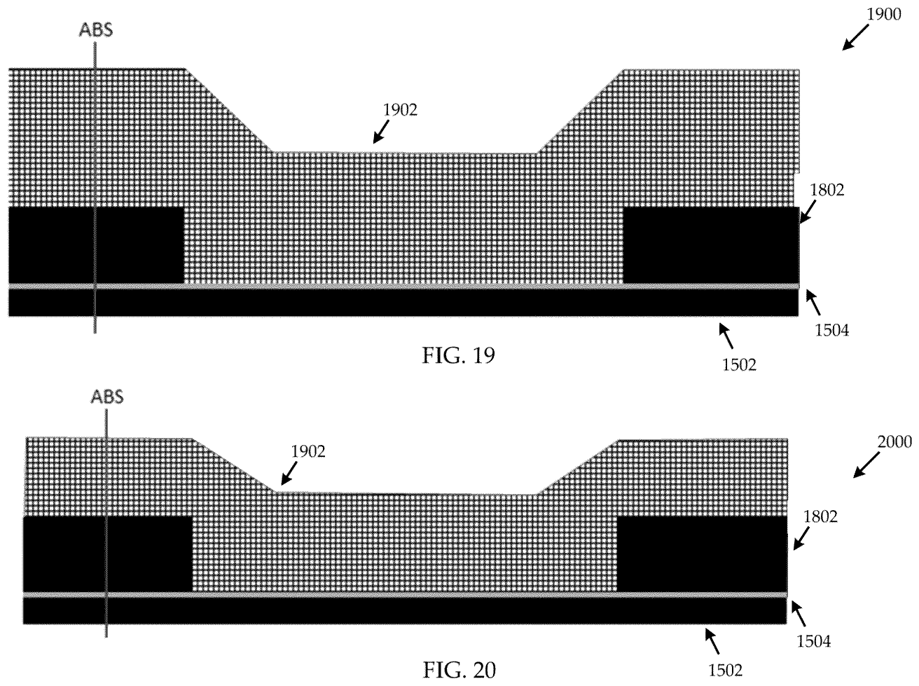

FIG. 19 is a block diagram 1900 of a fifth example part of a process to manufacture a AuCu bottom plasmonic layer. In FIG. 19, a AuCu BPG 1902 can be added above the dielectric spacer 1802 and the stopper 1504 to fill the cavity including an additional margin for flattening. The thickness of the BPG can be targeted for a growth grain. For example, if the final BPG AuCu film thickness is 50 nm, it can initially be 150 nm, which is three times that. With such a device, it is possible to increase the grain size of AuCu as shown in FIG. 1F.

FIG. 20 is a block diagram 2000 of a sixth example part of a process to manufacture a AuCu bottom plasmonic layer. In FIG. 20, after applying annealing, an IBE etching can be implemented to reduce the AuCu 1902 thickness.

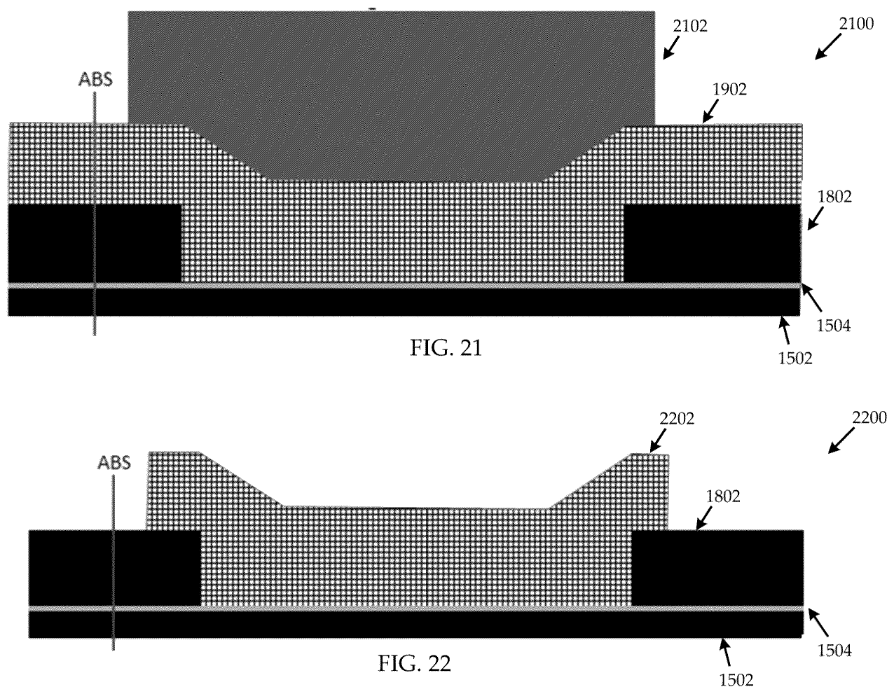

FIG. 21 is a block diagram 2100 of a seventh example part of a process to manufacture a AuCu bottom plasmonic layer. In FIG. 21, a pattern resist 2102 is added over the BPG 1902 to etch out an area of the AuCu BPG 1902 to make a CMP process easier.

FIG. 22 is a block diagram 2200 of an eighth example part of a process to manufacture a AuCu bottom plasmonic layer. In FIG. 22, after an IBE process, a portion of the AuCu is removed, leaving a portion of the AuCu BPG 2202 and removing the resist mask 2102.

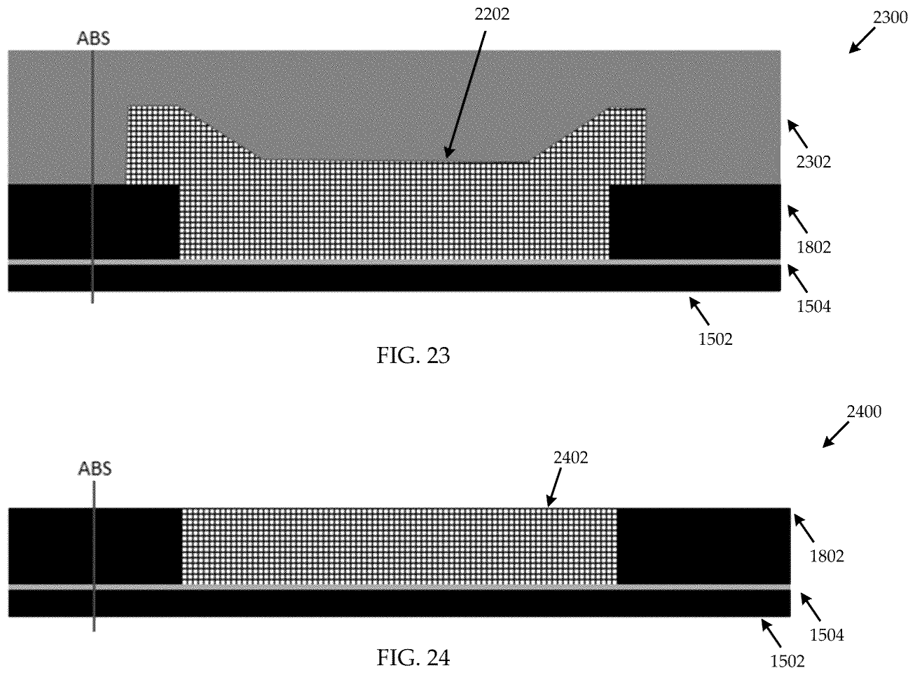

FIG. 23 is a block diagram 2300 of a ninth example part of a process to manufacture a AuCu bottom plasmonic layer. In FIG. 23, a dielectric film 2302 can be deposited for a CMP process. The film 2302 can be flattened by a CMP prior to applying an IBE process. This can allow for improved etching uniformity within wafer than CMP. IBE etching controllability may also be better than CMP.

FIG. 24 is a block diagram 2400 of a tenth example part of a process to manufacture a AuCu bottom plasmonic layer. In FIG. 24, the IBE process can remove part of the BPG to leave a portion of the BPG 2402.

In some instances, to make a cavity, IBE can be used instead of RIE. In such instances, the RIE stopper coating (e.g., 1504) does not need to be added. Without the RIE stopper, an IBE process can be applied to make the cavity in the dielectric spacer (e.g., in FIG. 18).

As described above, the present embodiments relate to a write head structure with an Ir PEG portion and a AuCu layer used as a PG layer. The write head can have an improve robustness while mitigating any ADC performance reduction. For example, the writer can include a HAMR write head with a bi-layer PPG structure. The writer can include an Ir film as a PG material and a AuCu alloy as the PG bottom plasmonic layer. The AuCu alloy can include between 3-15% Cu. Further, the AuCu alloy grain size can be 30 nm or larger.

In a first example embodiment, a heat-assisted magnetic recording (HAMR) write head is provided. The HAMR write head can include a main pole (e.g., 302 in FIG. 3) including a tip portion disposed adjacent to an air-bearing surface (ABS) (e.g., 310). The main pole can be configured to direct a magnetic field toward a magnetic recording medium (e.g., 218) to interact with the magnetic recording medium (e.g., to write digital data to the magnetic recording medium).

The HAMR write head can also include a heat sink (e.g., 306) disposed adjacent to the main pole and a bi-layer structure planar plasmon generator (PPG) structure (e.g., 314 and 316 in FIG. 3). The PPG structure can also include a plasmon generator (PG) layer (e.g., 314) comprising an Iridium (Ir) film and a bottom plasmonic layer (e.g., 308) comprising a gold-copper (Au—Cu) alloy.

In some instances, the bottom plasmonic layer comprises a portion of copper that is between 3 and 15 percent of the gold-copper alloy.

In some instances, a grain size of the bottom plasmonic layer is at least 30 nanometers.

In some instances, the HAMR device can further include a first dielectric spacer layer (e.g., 316) disposed between the main pole (e.g., 302) and the PG layer (e.g., 314).

In some instances, the HAMR device can further include a second dielectric spacer layer (e.g., 312) disposed adjacent to the bottom plasmonic layer (e.g., 308).

In some instances, the bottom plasmonic layer is disposed over the second dielectric spacer.

In some instances, a portion of the bottom plasmonic layer is removed via an etching process according to a resist mask (e.g., 604 in FIG. 6) disposed above the bottom plasmonic layer.

In some instances, a body layer (e.g., 1002) is disposed above the PG layer (e.g., 902), the body layer comprising Iridium, and wherein the first dielectric spacer is disposed above the body layer.

In another example embodiment, a device is provided. The device can include a main pole and a heat sink disposed adjacent to the main pole. The device can also include a bi-layer structure planar plasmon generator (PPG) structure. The PPG structure can include a plasmon generator (PG) layer comprising an Iridium (Ir) film and a bottom plasmonic layer comprising a gold-copper (Au—Cu) alloy. The device can also include a body layer disposed adjacent to the Ir film. The body layer can comprise Iridium. The device can also include a first dielectric spacer layer disposed between the main pole and the PG layer. The device can also include a second dielectric spacer layer disposed adjacent to the bottom plasmonic layer.

In some instances, a first portion of the bottom plasmonic layer is removed via an etching process based on a resist mask disposed above the bottom plasmonic layer.

In some instances, the bottom plasmonic layer is created by a manufacturing process that includes adding a reactive-ion etching (RIE) stopper layer (e.g., 1504) over the second dielectric layer (e.g., 1502). The process can also include disposing a dielectric cladding (e.g., 1602) over the RIE stopper layer. A portion of the dielectric cladding can be removed via an RIE etching process to form a cavity (e.g., remaining portion of cladding 1802 in FIG. 18). The process can also include depositing the bottom plasmonic layer (e.g., 1902) over the dielectric cladding and within the cavity. The process can also include removing a second portion of the bottom plasmonic layer (e.g., remaining portion of bottom plasmonic layer 2402) to be substantially flat with the dielectric cladding (e.g., 1802).

In some instances, the bottom plasmonic layer comprises between 3 and 15 percent copper.

In some instances, a grain size of the bottom plasmonic layer is at least 30 nanometers.

In another example embodiment, method for manufacturing a heat-assisted magnetic recording (HAMR) write head is provided. The method can include disposing a bottom plasmonic layer (e.g., 504) over a first dielectric layer (e.g., 502). The bottom plasmonic layer can include a gold-copper (Au—Cu) alloy. The method can also include disposing a plasmon generator (PG) layer (e.g., 902) comprising an Iridium (Ir) film over the bottom plasmonic layer (e.g., 504).

The method can also include disposing a body layer (e.g., 1002) comprising Iridium over the PG layer (e.g., 902). The method can also include disposing a second dielectric layer (e.g., 1202) and a heat sink (e.g., 1302) over the body layer. The method can also include disposing a main pole (e.g., 302 in FIG. 3) comprising a magnetic metallic material over the second dielectric layer and the heat sink.

In some instances, the method can also include disposing a non-magnetic main pole spacer (e.g., 1402) over the second dielectric layer and the heat sink. The non-magnetic main pole spacer can be disposed between the main pole and the second dielectric layer and the heat sink.

In some instances, the method can also include adding a resist mask over the bottom plasmonic layer and performing an etching process to remove a first portion of the bottom plasmonic layer.

In some instances, the method can also include patterning the body layer and the PG layer to a target dimension.

In some instances, the method can also include adding a reactive-ion etching (RIE) stopper layer over the second dielectric layer. The method can also include disposing a dielectric cladding over the RIE stopper layer. A portion of the dielectric cladding can be removed via an etching process to form a cavity. The method can also include depositing the bottom plasmonic layer over the dielectric cladding and within the cavity. The method can also include removing a second portion of the bottom plasmonic layer to be substantially flat with the dielectric cladding.

In some instances, the cavity is formed by performing any of a RIE etching process or an ion beam etching (IBE) etching process.

In some instances, responsive to depositing the bottom plasmonic layer over the dielectric cladding and within the cavity, the method further comprises adding a dielectric film over the bottom plasmonic layer. The dielectric film can be removed along with the removal of the second portion of the bottom plasmonic layer.

It will be understood that terms such as “top,” “bottom,” “above,” “below,” and x-direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

It will be appreciated that the term “present invention” as used herein should not be construed to mean that only a single invention having a single essential element or group of elements is presented. Similarly, it will also be appreciated that the term “present invention” encompasses a number of separate innovations, which can each be considered separate inventions. Although the present invention has been described in detail with regards to the preferred embodiments and drawings thereof, it should be apparent to those skilled in the art that various adaptations and modifications of embodiments of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

1. A heat-assisted magnetic recording (HAMR) write head comprising:
a main pole including a tip portion disposed adjacent to an air-bearing surface (ABS), the main pole configured to direct a magnetic field toward a magnetic recording medium to interact with the magnetic recording medium;
a heat sink disposed adjacent to the main pole; and
a bi-layer structure planar plasmon generator (PPG) structure comprising:
a plasmon generator (PG) layer comprising an Iridium (Ir) film;
a bottom plasmonic layer disposed adjacent to the PG layer and comprising a gold-copper (Au—Cu) alloy, wherein a grain size of the bottom plasmonic layer is at least 30 nanometers;
a first dielectric spacer layer disposed between the main pole and the PG layer;
a second dielectric spacer layer disposed adjacent to the bottom plasmonic layer; and
a reactive-ion etching (RIE) stopper layer disposed between the bottom plasmonic layer and the second dielectric layer.

2. The HAMR write head of claim 1, wherein the bottom plasmonic layer comprises a portion of copper that is between 3 and 15 percent of the gold-copper alloy.

3-5. (canceled)

6. The HAMR write head of claim 1, wherein the bottom plasmonic layer is disposed over the second dielectric spacer layer.

7. The HAMR write head of claim 6, wherein a portion of the bottom plasmonic layer is removed via an etching process according to a resist mask disposed above the bottom plasmonic layer.

8. The HAMR write head of claim 7, wherein a body layer is disposed above the PG layer, the body layer comprising Iridium, and wherein the first dielectric spacer layer is disposed above the body layer.

9. A device comprising:
a main pole;
a heat sink disposed adjacent to the main pole;
a bi-layer structure planar plasmon generator (PPG) structure comprising:
a plasmon generator (PG) layer comprising an Iridium (Ir) film; and
a bottom plasmonic layer comprising a gold-copper (Au—Cu) alloy;
a body layer disposed adjacent to the Ir film, the body layer comprising Iridium;
a first dielectric spacer layer disposed between the main pole and the PG layer;
a second dielectric spacer layer disposed adjacent to the bottom plasmonic layer; and
a reactive-ion etching (RIE) stopper layer disposed between the bottom plasmonic layer and the second dielectric layer.

10. The device of claim 9, wherein a first portion of the bottom plasmonic layer is removed via an etching process based on a resist mask disposed above the bottom plasmonic layer.

11. The device of claim 9, wherein the bottom plasmonic layer is created by a manufacturing process that includes:
adding the reactive-ion etching (RIE) stopper layer over the second dielectric layer;
disposing a dielectric cladding over the RIE stopper layer, wherein a portion of the dielectric cladding is removed via an RIE etching process to form a cavity;
depositing the bottom plasmonic layer over the dielectric cladding and within the cavity; and
removing a second portion of the bottom plasmonic layer to be substantially flat with the dielectric cladding.

12. The device of claim 9, wherein the bottom plasmonic layer comprises between 3 and 15 percent copper.

13. The device of claim 9, wherein a grain size of the bottom plasmonic layer is at least 30 nanometers.

14. A method for manufacturing a heat-assisted magnetic recording (HAMR) write head, the method comprising:
disposing a bottom plasmonic layer over a first dielectric layer, the bottom plasmonic layer comprising a gold-copper (Au—Cu) alloy;
disposing a plasmon generator (PG) layer comprising an Iridium (Ir) film over the bottom plasmonic layer;
disposing a body layer comprising Iridium over the PG layer;
disposing a second dielectric layer and a heat sink over the body layer; and
disposing a main pole comprising a magnetic metallic material over the second dielectric layer and the heat sink.

15. The method of claim 14, further comprising:
disposing a non-magnetic main pole spacer over the second dielectric layer and the heat sink, wherein the non-magnetic main pole spacer is disposed between the main pole and the second dielectric layer and the heat sink.

16. The method of claim 14, further comprising:
adding a resist mask over the bottom plasmonic layer; and
performing an etching process to remove a first portion of the bottom plasmonic layer.

17. The method of claim 14, further comprising:
patterning the body layer and the PG layer to a target dimension.

18. The method of claim 14, further comprising:
adding a reactive-ion etching (RIE) stopper layer over the second dielectric layer;
disposing a dielectric cladding over the RIE stopper layer, wherein a portion of the dielectric cladding is removed via an etching process to form a cavity;
depositing the bottom plasmonic layer over the dielectric cladding and within the cavity; and
removing a second portion of the bottom plasmonic layer to be substantially flat with the dielectric cladding.

19. The method of claim 18, wherein the cavity is formed by performing any of a RIE etching process or an ion beam etching (IBE) etching process.

20. The method of claim 18, wherein responsive to depositing the bottom plasmonic layer over the dielectric cladding and within the cavity, the method further comprises:
adding a dielectric film over the bottom plasmonic layer, wherein the dielectric film is removed along with the removal of the second portion of the bottom plasmonic layer.
